(19) United States
(12) Patent Application Publication
(10) Pub. No.: US 2015/0355144 A1
(43) Pub. Date: Dec. 10, 2015

(54) Systems and Methods for Measuring and Managing Site Inspection Profile Data

(71) Applicant: PoleXpert LLC, Carson City, NV (US)

(72) Inventor: Alexej Bartuli, La Canada Flintridge, CA (US)

(73) Assignee: PoleXpert LLC

(21) Appl. No.: 14/734,902

(22) Filed: Jun. 9, 2015

Related U.S. Application Data
(60) Provisional application No. 62/009,787, filed on Jun. 9, 2014.

(51) Int. Cl. G01N 29/12

(52) U.S. Cl. CPC G01N 29/12; G01N 2291/0238

(57) ABSTRACT

Systems and methods for measuring and managing pole integrity data and/or remaining strength data using pole integrity monitoring systems in accordance with embodiments of the invention are illustrated. In one embodiment, a site inspection device includes a processor and a memory connected to the processor and storing a site inspection application, wherein the site inspection application directs the processor to obtain site inspection data regarding a particular site having at least one structure, generate pole integrity data based on the site inspection data, where the pole integrity data describes the integrity of the at least one structure, generate site inspection profile data based on the site inspection data and the pole integrity data, and provide the site inspection profile data.

### CROSS-REFERENCE TO RELATED APPLICATIONS

The present applications claims the benefit of U.S. Provisional Patent Application No. 62/009,787, filed Jun. 9, 2014, the disclosure of which is hereby incorporated by reference in its entirety.

### FIELD OF THE INVENTION

The present invention relates to managing inspection data and more specifically systems and methods for measuring and managing data related to the integrity and the quality of objects' remaining strength.

### BACKGROUND OF THE INVENTION

Support structures, such as wooden poles, are common features along municipal landscapes. These structures are primarily used as support structures for power lines and other utility services such as telephone cables or fiber optics and equipment such as transformers and streetlights. While some cities have recently begun installing power lines or cables underground, a significant number of wooden poles remain as the primary support structure. Moreover, burying cables underground can be cost prohibitive. Given the large number of such structures in existence, the ability to preserve the wooden poles and characterize the integrity and/or remaining strength of the structures over time is paramount, as replacing the poles is labor intensive and can involve considerable costs. In addition, since many of the wooden poles are located in highly populated areas, pole replacement can be disruptive, causing road closures or possible disruption of services and/or slowdown of pedestrian traffic near the affected area.

Various inspection and maintenance programs are performed in order to identify and remove damaged wooden structures. Many programs utilize visual inspection as a primary means for determining the integrity of the wooden structures. Since visual assessment requires that individuals visually inspect each structure, this type of analysis is time consuming and labor intensive as the individual must inspect all parts of the structure's external surface and note any indications of possible damage. Visual inspection offers limited useful information in the assessment analysis and can be problematic because the measurements are subjective, deterioration over a period cannot be properly quantified, nor can the underground or internal aspects of the wooden structure be properly accessed.

### SUMMARY OF THE INVENTION

Systems and methods for measuring and managing pole integrity data and/or remaining strength data using pole integrity monitoring systems in accordance with embodiments of the invention are illustrated. In one embodiment, a site inspection device includes a processor and a memory connected to the processor and storing a site inspection application, wherein the site inspection application directs the processor to obtain site inspection data regarding a particular site having at least one structure, generate pole integrity data based on the site inspection data, where the pole integrity data describes the integrity of the at least one structure, generate site inspection profile data based on the site inspection data and the pole integrity data, and provide the site inspection profile data.

In another embodiment of the invention, the site inspection data is obtained using a pole integrity meter.

In an additional embodiment of the invention, the pole integrity meter includes a processor and a vibration sensor and the pole integrity meter measures the structural integrity of a structure in the at least one structure by inputting one or more strength determining characteristics of the structure into the pole integrity meter, applying the vibration sensor to the structure, creating a vibrational frequency signal within the structure, measuring said frequency signal with the vibration sensor, analyzing the measured frequency signal, and providing data output of the analyzed frequency signal.

In yet another additional embodiment of the invention, the site inspection application further directs the processor to generate pole integrity data based on the provided data output of the pole integrity meter and include the pole integrity data in the site inspection profile data.

In still another additional embodiment of the invention, the site inspection device further includes the pole integrity meter.

In yet still another additional embodiment of the invention, the at least one structure includes a utility pole.

In yet another embodiment of the invention, the utility pole is identified using a utility pole identifier and the site inspection application further directs the processor to obtain utility pole identifier data describing the utility pole and include the utility pole identifier data in the site inspection profile data.

In still another embodiment of the invention, the site inspection device further includes a global positioning system (GPS) receiver and the site inspection application further directs the processor to obtain location data using the GPS receiver and include the location data into the site inspection data.

In yet still another embodiment of the invention, the site inspection profile data is provided to a pole integrity monitoring server system.

In yet another additional embodiment of the invention, the site inspection application further directs the processor to capture image data regarding the at least one structure, identify calibration tool data within the image data, where the calibration tool data describes a calibration tool applied to the at least one structure, measure the at least one structure based on the captured image data and the identified calibration tool to generate structure measurement data, and include the structure measurement data in the site inspection profile data.

Still another embodiment of the invention includes a method for performing a site inspection, including obtaining site inspection data regarding a particular site having at least one structure using a site inspection device, where the site inspection device includes a processor and a memory, generating pole integrity data based on the site inspection data using the site inspection device, where the pole integrity data describes the integrity of the at least one structure, generating site inspection profile data based on the site inspection data and the pole integrity data using the site inspection device, and providing the site inspection profile data using the site inspection device.

In yet another additional embodiment of the invention, the site inspection data is obtained using a pole integrity meter.

In still another additional embodiment of the invention, the pole integrity meter includes a processor and a vibration sensor and the pole integrity meter measures the structural integrity of a structure in the at least one structure by inputting one or more strength determining characteristics of the structure into the pole integrity meter, applying the vibration sensor to the structure, creating a vibrational frequency signal within the structure, measuring said frequency signal with the vibration sensor, analyzing the measured frequency signal, and providing data output of the analyzed frequency signal.

In yet still another additional embodiment of the invention, the method further includes generating pole integrity data based on the provided data output of the pole integrity meter using the site inspection device and including the pole integrity data in the site inspection profile data using the site inspection device.

In yet another embodiment of the invention, the site inspection device further includes the pole integrity meter.

In still another embodiment of the invention, the at least one structure includes a utility pole.

In yet still another embodiment of the invention, the method further includes obtaining utility pole identifier data describing the utility pole using the site inspection device and including the utility pole identifier data in the site inspection profile data using the site inspection device.

In yet another additional embodiment of the invention, the method further includes obtaining location data using the site inspection device and including the location data into the site inspection data using the site inspection device.

In still another additional embodiment of the invention, the site inspection profile data is provided to a pole integrity monitoring server system.

In yet still another additional embodiment of the invention, the method further includes capturing image data regarding the at least one structure using the site inspection device, identifying calibration tool data within the image data, where the calibration tool data describes a calibration tool applied to the at least one structure using the site inspection device, measuring the at least one structure based on the captured image data and the identified calibration tool to generate structure measurement data using the site inspection device, and including the structure measurement data in the site inspection profile data.

### BRIEF DESCRIPTION OF THE DRAWINGS

FIG. 1 is a network diagram of a pole integrity monitoring system in accordance with an embodiment of the invention.

FIG. 2A is a conceptual illustration of a pole integrity monitoring server system in accordance with an embodiment of the invention.

FIG. 2B is a conceptual illustration of a pole integrity meter in accordance with an embodiment of the invention.

FIG. 2C is a conceptual illustration of a site inspection device in accordance with an embodiment of the invention.

FIG. 3A is a conceptual illustration of a user interface for measuring and recording inspection data in accordance with an embodiment of the invention.

FIG. 3B is a flowchart illustrating a process for measuring pole integrity data and site inspection data in accordance with an embodiment of the invention.

FIGS. 4A and 4B are conceptual illustrations of a user interface for calibrating and measuring the size of a utility pole in accordance with an embodiment of the invention.

FIG. 4C is a flowchart illustrating a process for measuring the size of a utility pole in accordance with an embodiment of the invention.

FIG. 5 is a conceptual illustration of a user interface for managing site inspection profile data in accordance with an embodiment of the invention.

FIG. 6 is a flowchart illustrating a process for generating site inspection profile data in accordance with an embodiment of the invention.

FIG. 7A is a conceptual illustration of a user interface for viewing integrity data for an object in accordance with an embodiment of the invention.

FIG. 7B is a flowchart illustrating a process for generating integrity data for an object in accordance with an embodiment of the invention.

FIG. 8 is a flowchart illustrating a process for generating site report data in accordance with an embodiment of the invention.

### DETAILED DISCLOSURE OF THE INVENTION

Turning now to the drawings, pole integrity monitoring systems in accordance with embodiments of the invention are illustrated. Support structures, such as wooden utility poles, have played a vital role in establishing the electrical system as electrical transmission and distribution lines, as well as cable and fiber optic lines, deliver power and other services to large cities, small towns, and rural outposts. Numerous factors are associated with the deterioration of utility poles. While the type of wooden structures used by municipalities may differ, i.e. western red cedar, Douglas fir, and any other species of wood, deterioration is common to all types of wooden structures. Most wooden structures are susceptible to various environmental attacks, such as the gradual deterioration resulting from internal damage caused by insect attack. Termites, ants, and woodborers damage the internal composition of the wood structures that is difficult to accurately and properly access through external visualization techniques. The damage caused by the bio-attack often results in a relatively slow decay process, leaving the pole subject to failure at unpredictable times. Wood destroying fungi are another environmental hazard that results in weakening of the integrity of the wood structures. These structures can be treated to minimize the damage caused by such organisms. However, the chemical preservation procedures are not failsafe. For example, chemical preservation treatments often include boring and injection of the chemicals into the structure's internal environment. The boring process, any cuts and/or injection sites can form a focus point for damage and decay. In addition, soil can affect the strength of the pole. For example, if the soil contains acid components, the acid destroys timber fibers and leads to the reduction of pole strength at a faster rate than soils that are less acidic. The presence of big cracks, knots, or moisture can also result in the reduction of pole strength. For poles not made of wood fibers, other factors may be important. For concrete poles, the corrosion of reinforcement can result in reduction in pole strength. Environmental conditions, such as extreme heat, cold, moisture, and/or lack of rainfall can result in accelerated damage because of the environmental conditions and/or through increase in organism attack.

Conventional wooden poles inspection practice includes sounding, visual inspection and intrusive (destructive) boring/drilling. Both sounding and visual inspections are subjective, time consuming, and do not give the whole representation of poles conditions. Conventional drilling techniques are highly destructive. The holes remaining in the poles after drilling provide easy access for water, oxygen, and fungi to enter the untreated portions of the pole. As utility poles are designed to have a useful lifespan of several decades, these drilling techniques actually shorten the useful lifespan of the utility poles even as they measure the condition of the pole. Studies evaluating the impact of each inspection's drill hole estimate that each hole drilled in a wooden utility pole can have as much as a 5% decrease in the remaining strength over the remaining lifetime of the pole.

Even if a pole has no defects, the starting strength may be less than the statistical maxim. Because the utility poles support vertical, longitudinal, and transverse loads caused by wire tension, weight of coupled objects, and wind, the pole's structural characteristics must be monitored over their lifetime to obtain maximum useful life. In order to successfully monitor the structure over a period of time, the ability to determine the overall integrity is paramount. Continuous monitoring provides pole owners the capability of preventing, or at least minimizing, unexpected load failure, thereby reducing the risk of pole collapse, human injury, and property damage. Knowing the pole integrity and remaining strength allows pole owners a reliable mechanism to determine if the structure should be repaired or replaced. Knowing the structural integrity and maximal horizontal load parameter of the poles further allows pole owners the ability to predict replacement times, thereby providing better budgeting analysis and accommodations. Characterizing the structural integrity of each pole further allows the owner the capability to remove excess load that could cause immediate failure or deterioration.

Pole integrity monitoring systems in accordance with embodiments of the invention are configured to facilitate the measurement of pole integrity and the management of a variety of utility poles. Pole integrity monitoring systems include pole integrity meters configured to determine the integrity of objects such as utility poles. Pole integrity data describing the integrity of objects includes, but is not limited to a determination of changes in geometric structure parameters, bending strength, conditions of embodiment and anchoring of the utility pole within the soil, pole capacity, and pole stability. In many embodiments, pole integrity meters characterize the internal deterioration of the object based on structure model data describing the deterioration parameters of the structures. By determining these internal deterioration characteristics, pole integrity data describing the integrity of the pole can be determined, assessed, and monitored. The amount of weight the structures can bear without resulting in failure can be used to prevent unexpected failure and help extend the life of the existing structures. Pole integrity monitoring systems also include site inspection devices configured to record data regarding the site and the object being measured. As described in more detail below, the site inspection data can include visual observations of the site and the utility pole being measured, such as visible damage on the utility pole, the height and/or angle of the utility pole leaning, soil conditions, embedding/compaction condition, and/or any other data as appropriate to the requirements of specific applications of the invention. Site inspection profile data can then be created using the pole integrity data and the site inspection data along with any other metadata, such as the time the inspection occurred and the geographical location of the utility pole. The site inspection profile data can then be used to provide an interface for viewing and managing the conditions for a variety of utility poles. Additionally, models of the utility poles can be generated based on the site inspection profile data that allow for the analysis and tracking of the condition of a variety of utility poles over time. In this way, pole integrity management systems facilitate the determination of when utility poles should be serviced and/or replaced. This information can be transmitted to pole integrity meters and/or site inspection devices to facilitate the maintenance and repair of utility poles in the field. Furthermore, pole integrity monitoring systems allow the tracking and monitoring of workforce performance as each step of a crew is recorded with their geographical (global positioning system (GPS)) location, time, photograph(s) (some of them), and/or altitude above sea level. This data gives the ability to not only control and enhance the workforce ethics, but also can help increase safety significantly. Additionally, site inspection data and/or site inspection profile data can be utilized to generate a variety of reporting data for a site and/or projects, such as financial planning data and/or generation of work order data.

Although the above is described with respect to utility poles, any object and workflow process can be measured and monitored as appropriate to the requirements of specific applications of the invention. Pole integrity monitoring systems in accordance with embodiments of the invention are discussed further below.

### Pole Integrity Monitoring Systems

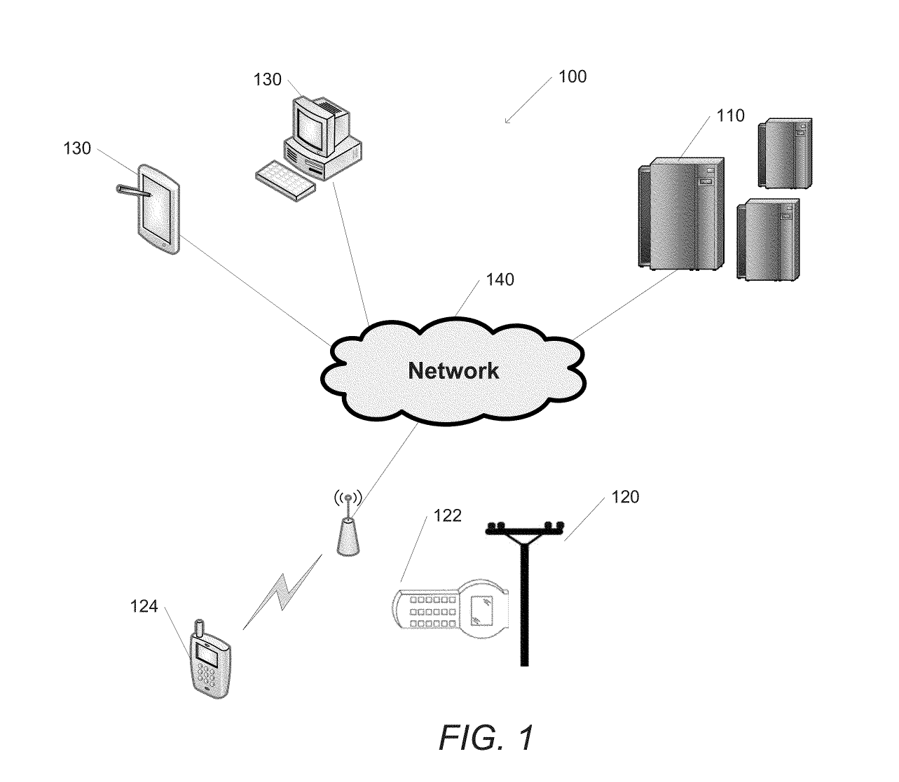

A pole integrity monitoring system in accordance with an embodiment of the invention is illustrated in FIG. 1. The pole integrity monitoring system 100 includes a pole integrity monitoring server system 110, one or more pole integrity meters 122 configured to measure the integrity of a variety of utility poles 120, one or more site inspection devices 124 configured to measure site inspection data, and a plurality of client devices 130 connected via a network 140. In a number of embodiments, the network 140 is the Internet, although any network can be utilized as appropriate to the requirements of specific applications of the invention.

In many embodiments, the pole integrity meter 122 and the site inspection device 124 are implemented using a single device. In a variety of embodiments, the pole integrity meter 122 lacks a network connection and transfers pole integrity data directly to the site inspection device 124 manually or via a wired and/or wireless connection. In several embodiments, the pole integrity meter 122 and/or site inspection device 124 is configured to communicate with a pole integrity monitoring server system 110 to display site inspection profile data as a client device 130.

Pole integrity monitoring server system 110 can be configured to obtain site inspection profile data from the pole integrity meter 122 and/or the site inspection device 124. In many embodiments, the pole integrity monitoring server system 110 is configured to obtain site inspection data and pole integrity data and generate site inspection profile data based on the obtained pieces of data. In many embodiments, the site inspection monitoring server system 110 is configured to provide site inspection profile data to the site inspection devices 124 and/or the pole integrity meters 122. In this way, the site inspection devices 124 and/or the pole integrity meters 122 can be pre-loaded with information regarding particular sites and utility poles. This information can then be confirmed and/or updated as part of the site inspection. Additionally, this information can be utilized to assist in the identification and/or repair of utility poles in the field.

Client devices 130 include a variety of computing devices, including personal computers, tablets, mobile phones, and/or any other computing device capable of communicating via network 140 to obtain site inspection profile data from the pole integrity monitoring server system 110. In many embodiments, the client devices 130 obtain site inspection profile data from the site inspection monitoring server system 110 and generate integrity models. These integrity models can then be viewed using the client devices to further visualize and explore the utility poles. In several embodiments, the site inspection monitoring server system 110 is configured to generate the integrity models and transmit the models to the client devices 130. In a number of embodiments, the client devices 130 generate metadata describing actions to be taken with respect to one or more utility poles. This metadata can be included in the site inspection profile data that is transmitted to the site inspection monitoring server system 110 and/or site inspection device 124. This facilitates instructing engineers to take particular actions described in the site inspection profile data with respect to a variety of utility poles 120 as appropriate to the requirements of specific applications of the invention.

In a variety of embodiments, the site inspection monitoring server system 110 and/or site inspection device 124 provides a user interface allowing for visualizing and interacting with the data. In several embodiments, the site inspection monitoring server system 110 and/or site inspection device 124 provides an interface, such as an application programming interface (API) or web service that provides some or all of the data to third-party systems for further processing. Access to the interface can be open and/or secured using any of a variety of techniques, such as by using client authorization keys, as appropriate to the requirements of specific applications of the invention.

Although a specific architecture for a pole integrity monitoring system in accordance with an embodiment of the invention is conceptually illustrated in FIG. 1, any of a variety of architectures appropriate to the requirements of a specific application can be utilized in accordance with embodiments of the invention. Systems and methods for pole integrity monitoring server systems in accordance with embodiments of the invention are discussed further below.

### Pole Integrity Monitoring Server Systems

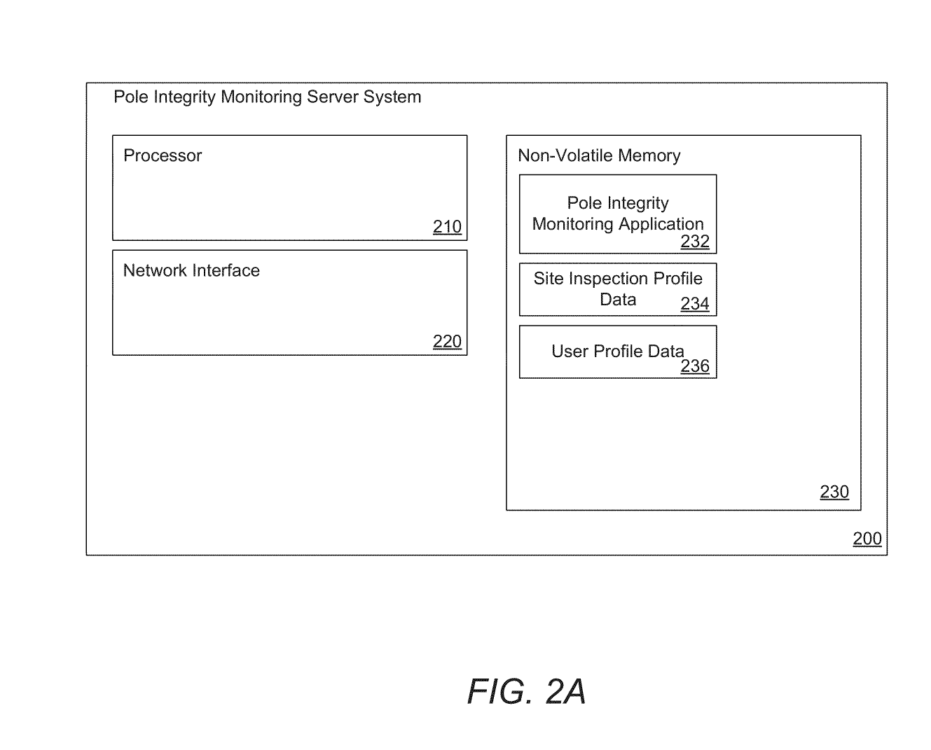

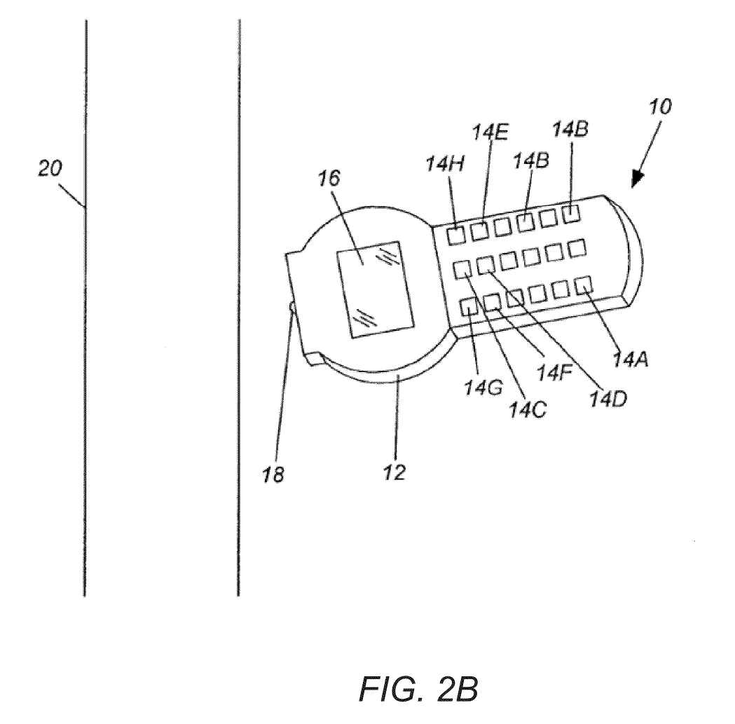

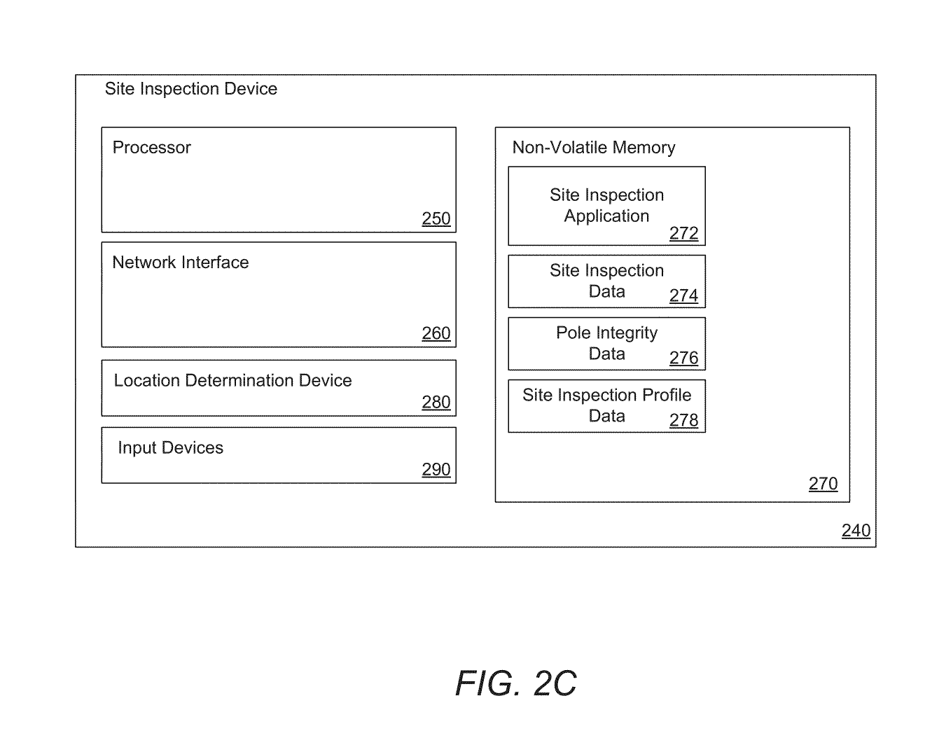

Pole integrity monitoring server systems in accordance with embodiments of the invention are configured to obtain information regarding site inspections and pole integrity data, provide a historical record of the received information, and generate models describing the integrity and conditions surrounding a variety of utility poles. In this way, the conditions for a variety of utility poles can be tracked and the necessary repairs and/or replacement of utility poles can be performed before the utility pole fails. A pole integrity monitoring server system in accordance with an embodiment of the invention is conceptually illustrated in FIG. 2A. The pole integrity monitoring server system 200 includes a processor 210 in communication with memory 230. The pole integrity monitoring server system 200 also includes a network interface 220 configured to send and receive data over a network connection. In a number of embodiments, the network interface 220 is in communication with the processor 210 and/or the memory 230.

In several embodiments, memory 230 is any form of storage configured to store a variety of data, including, but not limited to, a pole integrity monitoring application 232, site inspection profile data 234, and user profile data 236. The pole integrity monitoring application 232 configures the processor 210 to perform pole integrity monitoring processes. These processes can include obtaining site inspection profile data 234 including site inspection data and pole integrity data received from site inspection devices and/or pole integrity meters. In a variety of embodiments, the pole integrity monitoring process includes generating the site inspection profile data 234 based on site inspection data and pole integrity data received from site inspection devices and/or pole integrity meters. The site inspection data and the pole integrity data are described in more detail below.

In many embodiments, the site inspection profile data is associated with one or more users described using user profile data 234. User profile data can include a variety of demographic information related to one or more engineers and/or operators. In this way, particular utility poles can be assigned to one or more engineers. Site inspection devices can then be assigned to particular engineers using the user profile data 234 and the site inspection profile data 232 corresponding to the engineers can be automatically transmitted to their site inspection devices. In this way, the data associated with particular utility poles is available to the relevant engineers when performing site inspections and can be updated and/or modified as appropriate to the requirements of specific applications of the invention.

In a variety of embodiments, pole integrity monitoring processes including generating models of the utility poles described using the site inspection profile data 234. These models can be utilized by the engineers to analyze the structural integrity of a utility pole based on the inspection of the utility pole. The models can then be utilized to determine recommendations for repairing and/or replacing the utility poles. Additionally, access to the models can be restricted based on the user profile data 234. In this way, particular engineers can be assigned to review particular utility poles. This can be very beneficial for a variety of reasons, including separating the set of engineers analyzing the integrity of the utility poles from the engineers inspecting and working on those poles. This can facilitate the accurate identification of potential failures and the repair of those failures as the user profile data 234.

In a variety of embodiments, the memory 230 includes circuitry such as, but not limited to, memory cells constructed using transistors, that are configured to store instructions. Similarly, the processor 210 can include logic gates formed from transistors (or any other device) that are configured to dynamically perform actions based on the instructions stored in the memory. In several embodiments, the instructions are embodied in a configuration of logic gates within the processor to implement and/or perform actions described by the instructions. In this way, the systems and methods described herein can be performed utilizing both general-purpose computing hardware and by single-purpose devices.

### Pole Integrity Meters

In many embodiments, pole integrity data is measured using a pole integrity meter. A conceptual illustration of a pole integrity meter and a pole to be measured is shown in FIG. 2B. The pole integrity meter 10 contains an outer casing 12 that encloses the internal components of the device, including a power source such as a battery, a processor, a data storage device, signal converter devices, and the internal circuitry for performing its intended functions. The external components of the device include one or more command buttons referred to generally as 14, and a data display unit 16. In several embodiments, the command buttons 14 include a power on/off button 14A, buttons that allow the user to input numbers or letters 14B, arrow buttons 14C-14F, or other command buttons 14G-14H that allow the user to navigate the software system utilized with the device and visibly displayed on the data display unit 16. The digital display unit 16 is preferably one or more LCD screens, but may be any other display-type unit known to one of skill in the art. In a variety of embodiments, the device 10 may contain one or more capacitance-based and/or touch screen technology to allow the user to navigate the device using on screen commands or manipulation.

The pole integrity meter 10 further contains one or more detecting elements designed to detect a specific signal or frequency. Detecting elements include sonic or seismic sensor(s) 18, although any detection element can be utilized as appropriate to the requirements of specific applications of the invention. The pole integrity meter 10 is preferably a hand-held device that can be carried within a pocket or holder. A variety of pole integrity meters are described in U.S. Patent Publication No. 2014/0069192 to Bartuli et al., titled “Pole Integrity Meter and Method of Determining Pole Integrity” and filed Sep. 7, 2012, that can be utilized in pole integrity monitoring systems in accordance with a number of embodiments of the invention. The disclosure of U.S. Patent Publication No. 2014/0069192 is hereby incorporated by reference in its entirety.

The pole integrity meter 10 is adapted to measure the vibrations of the pole structure 20 and transduce the vibration frequency into an electrical signal. The pole integrity meter 10 can be used to determine the structural integrity of wooden poles and a variety of other structures, including cement structures, as the description of the wooden poles used throughout the description is not intended to be limiting. The pole integrity meter 10 contacts the utility pole 20 in order to measure any sound waves or seismic activity. Preferably, the sensor is capable of detecting any signal without the need for puncturing the outer surface of the utility pole 20. In this manner, the pole integrity meter 10 is non-intrusive and does not contribute to deterioration by creating areas that expose the structure to oxygen, water, and possible fungal attack. With the pole integrity meter 10 in contact with the utility pole 20, a seismic moment is created by striking the utility pole 20 with a mallet or via any other means of generating a seismic moment within the utility pole 20. In several embodiments, the pole integrity meter 10 is configured to generate its own seismic moment without the need for an external mallet or other device. The seismic moment created an acoustic signal in the utility pole 20 that is detected using the pole integrity meter 10. The acoustic signal detected by the sensor is analyzed by an analysis module by receiving the response, or acoustic signal, from the strike and transducing that acoustic signal into a usable signal that can be manipulated by filtering out non-essential noise or signal, rejection of signals produced by other objects, and a determination if the signal fits a pole model.

The software program is designed to convert the signal into a value that is used to either determine the strength of the structure or determine other characteristics that can be used to determine the strength of the structure. In several embodiments, the acoustic signal is converted into an analog electrical signal and transformed into a digital signal using a digital converter. The digital signal is stored as pole integrity data into a memory in the pole integrity meter 10, such as but not limited to non-volatile memory. Pole integrity data stored in the memory or converted through the digital converter can be used to create the necessary information through use of an analysis module, such as software executed by a processor in the pole integrity meter 10. The pole integrity data can be displayed to the end user via a display module. The pole integrity data can include, but is not limited to, data describing the relationship between the utility pole's natural structure frequencies, which is determined by the frequency generated by the mallet strike, and the pole's mechanical and geometrical characteristics, including but not limited to elastic modulus, the density of the structure, and the cross-section area. Determining one or more of the utility pole's mechanical and geometrical characteristics allows for a determination of the pole's current overall strength as the mechanical and geometrical characteristics reflect the presence of any decay, such as rotting, cracks, or presence of fungal infection, within the internal environment of the utility pole. In a variety of embodiments, structure model data describing the characteristics of a particular construction of object (e.g. wooden poles, concrete poles, steel poles, etc. . . . ) can be utilized in the determination of the pole integrity data along with the measured acoustic signal. In this way, the pole integrity data can be specifically calculated for the particular variety of material used to construct the utility pole.

In a variety of embodiments, the pole integrity data can be transmitted using a network device to a site inspection device and/or a pole integrity monitoring server system. Networking devices include, but are not limited to, cellular modems, 802.11 wireless networking device, Bluetooth modules, wired network connections, and/or any other device for transferring data between devices as appropriate to the requirements of specific applications of the invention. In a variety of embodiments, the pole integrity data is combined with site inspection data to create a complete view of the utility pole 20 that can be utilized to determine the structural integrity and potential loading changes for the utility pole 20.

### Site Inspection Devices

Site inspection devices in accordance with embodiments of the invention are configured to obtain a variety of information regarding the site of a utility pole. This information can then be combined with information measured using a pole integrity meter to generate site inspection profile data, providing a complete picture of a utility pole and the environment in which the utility pole is installed. A site inspection device in accordance with an embodiment of the invention is conceptually illustrated in FIG. 2C. The site inspection device 240 includes a processor 250 in communication with memory 270. The site inspection device 240 also includes a network interface 260 configured to send and receive data over a network connection. In a number of embodiments, the network interface 260 is in communication with the processor 250 and/or the memory 270. In a variety of embodiments, the site inspection device 240 includes a location determination device 280 configured to obtain location information for the site inspection device. Any of a variety of location determination devices, such as Global Positioning System (GPS) receivers, devices configured to perform cellular tower triangulation, Internet Protocol (IP) geolocation services, and any other location determination device can be utilized as appropriate to the requirements of specific applications of the invention. The site inspection device 240 also includes a variety of input devices 290, including, but not limited to, cameras configured to capture image data and/or video data, keyboards and/or touchscreens configured to receive text and/or gesture input, microphones configured to capture audio data, and/or any other input device configured to capture data that can be utilized to describe a site inspection as appropriate to the requirements of specific applications of the invention. In a variety of embodiments, the input devices 290 can be separate from the site inspection device 240 and transmit data to the site inspection device 240. For example, an input device can be a panoramic camera that is capable of transmitting captured image data to the site inspection device via a wireless connection.

In several embodiments, memory 270 is any form of storage configured to store a variety of data, including, but not limited to, a site inspection application 272, site inspection data 274, pole integrity data 276, and site inspection profile data 278. The site inspection application 272 configures the processor 250 to perform site inspection processes. These processes can include obtaining site inspection data 274 and pole integrity data 276 from one or more pole integrity meters. In a variety of embodiments, site inspection processes include generating site inspection profile data 278 based on site inspection data 274 and pole integrity data 276. Additionally, site inspection data 274, pole integrity data 276, and/or site inspection profile data 278 can be obtained using the network interface 260. Similarly, the various pieces of data can be transmitted using the network interface 260.

A variety of data can be incorporated into the site inspection data 274 and/or pole integrity data 276 and thereby site inspection profile data 278 generated based on the site inspection data 274 and pole integrity data 276. This data includes, but is not limited to, an identifier for the pole, the zip code (and/or geolocation information determined using a location determination device) associated with the pole, the height of the pole, the length of the pole, the circumference of the pole, the diameter of the pole, the date the pole was installed, the construction (e.g. the species of wood, the concrete mix, the type of metal, etc. . . . ) of the pole, a previously measured integrity rating of the pole, the angle of the pole relative to the ground, any damage identified on the pole, objects attached to the pole, load points for the pole, text notes, audio data, video data, image data, a recommendation regarding the actions to be taken with respect to the pole, the company and/or project associated with the pole, and the engineers associated with the pole. In many embodiments, the site inspection data 274 and/or site inspection profile data 278 can include text data and/or audio data providing descriptive metadata regarding the site and/or inspection. Additionally, pole structure data can be incorporated into the site inspection data 274, site inspection data 276, and/or site inspection profile data 278. Any subset of this data and/or additional data can be utilized in the site inspection data as appropriate to the requirements of specific applications of the invention. In particular, it should be noted that any damage, attachment points, load points, or any other point of interest could be flagged and included in the site inspection profile data. In addition, the specific orientation of the points of interest, including the relative position of the point of interest on the utility pole and the height of the point of interest on the utility pole can be included in the site inspection profile data.

In a variety of embodiments, the memory 270 includes circuitry such as, but not limited to, memory cells constructed using transistors, that are configured to store instructions. Similarly, the processor 250 can include logic gates formed from transistors (or any other device) that are configured to dynamically perform actions based on the instructions stored in the memory. In several embodiments, the instructions are embodied in a configuration of logic gates within the processor to implement and/or perform actions described by the instructions. In this way, the systems and methods described herein can be performed utilizing both general-purpose computing hardware and by single-purpose devices.

Specific architectures for pole integrity monitoring server systems, site inspection devices, and pole integrity meters in accordance with embodiments of the invention are conceptually illustrated in FIGS. 2A-2C; however, any of a variety of architectures, including those which store data or applications on disk or some other form of (non-transitory) storage and are loaded into memory at runtime, and or systems that are distributed across multiple physical servers, can also be utilized. Techniques for measuring and monitoring pole integrity in accordance with embodiments of the invention are discussed further below.

### Inspecting Sites

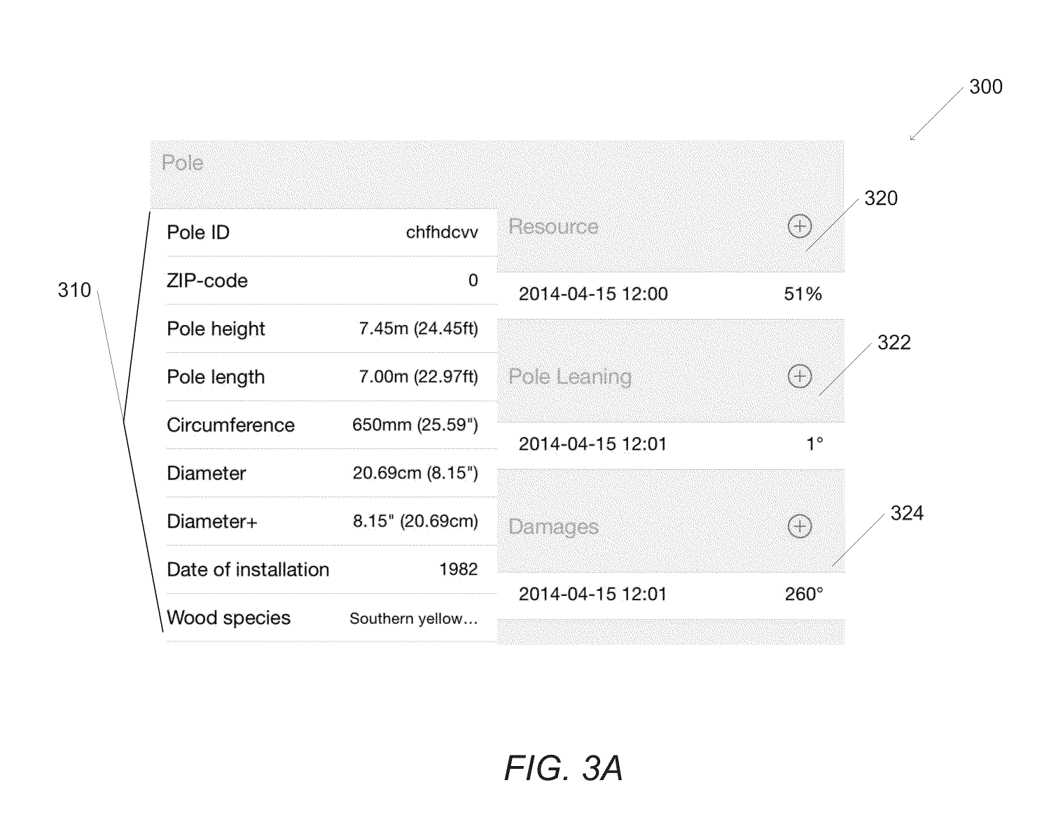

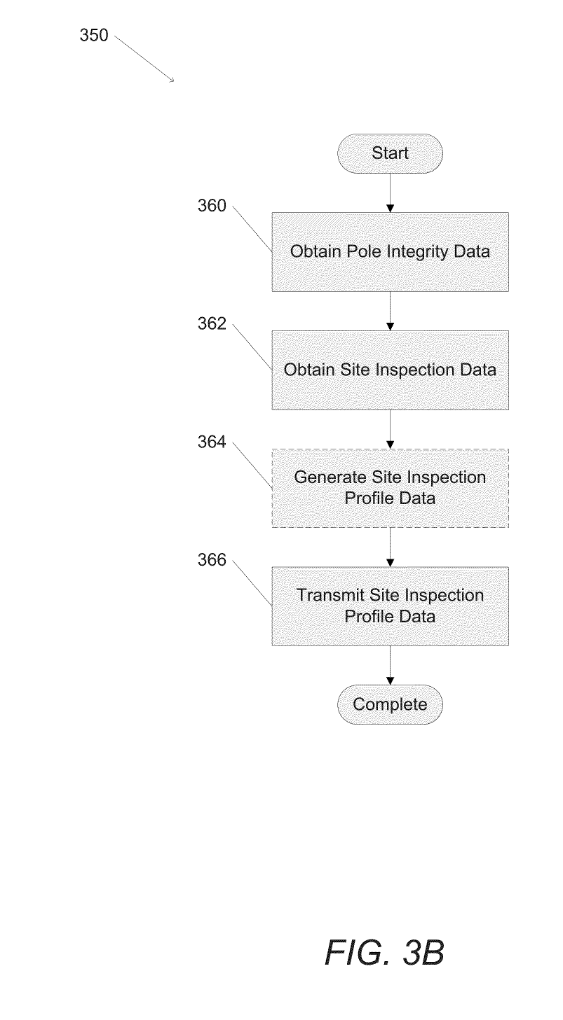

During the inspection of a site, both the integrity of the utility pole and the properties of the site in which the utility pole is installed are measured. These measurements include both a visual inspection of the utility pole along with a description of the location of the utility pole and the surrounding area. Turning now to FIG. 3A, a user interface conceptually illustrating a set of site inspection data is shown. The user interface 300 includes a set of utility pole data 310, measured pole integrity data 320, pole leaning data 322, and identified damages 324. The utility pole data includes data describing the properties of the utility pole, including but not limited to, an identifier for the pole, the zip code (and/or geolocation information determined using a location determination device) associated with the pole, the height of the pole, the length of the pole, the circumference of the pole, the diameter of the pole, the date the pole was installed, and the construction (e.g. the species of wood, the concrete mix, the type of metal, etc. . . . ) of the pole. The measured pole integrity data 320 can be generated based on pole integrity data obtained from a pole integrity meter and/or received as part of a piece of site inspection profile data. The pole leaning 322 can be measured utilizing techniques described below. The damages 324 include points of interest identified regarding the utility pole along with a location on the utility pole. As described below, the damages 324 can be visualized using modeling data in order to better understand the condition of a particular utility pole and make recommendations concerning future actions to take with respect to the utility pole. In a number of embodiments, text data, image data, video data, and/or audio data regarding the damages 324 is also captured using a site inspection device and associated with the damages 324.

A flow diagram conceptually illustrating a process for measuring pole integrity data and site inspection data in accordance with an embodiment of the invention is shown in FIG. 3B. The process 350 includes obtaining (360) pole integrity data and obtaining (362) site inspection data. In a variety of embodiments, site inspection profile is generated (364). Site inspection profile data is transmitted (366). As described above, the pole integrity data can be obtained (360) from a pole integrity meter. The site inspection data can be obtained (362) using a site inspection device. Additionally, the pole integrity data, the site inspection data, and/or site inspection profile data can be obtained from a site inspection monitoring server system, pre-loaded on the site inspection device, then updated based on the current site conditions.

In several embodiments the site inspection data and/or site inspection profile data can be filtered based on user preference data and/or user privilege data. The preferences and/or privilege for a particular user can be set on a per-site and/or a per-project basis. In this way, the site inspection data and/or site inspection profile data that is relevant to a particular user can be displayed. However, any of a variety of data selection and/or filtering techniques can be utilized as appropriate to the requirements of specific applications of embodiments of the invention.

Although a specific user interface for obtaining site inspection data and a specific process for obtaining site inspection data in accordance with an embodiment of the invention is conceptually illustrated in FIGS. 3A and 3B, any of a variety of interfaces and processes can be utilized as appropriate to the requirements of a specific application in accordance with embodiments of the invention. Processes for measuring the integrity of utility poles in accordance with embodiments of the invention are described in more detail below.

### Measuring Utility Poles

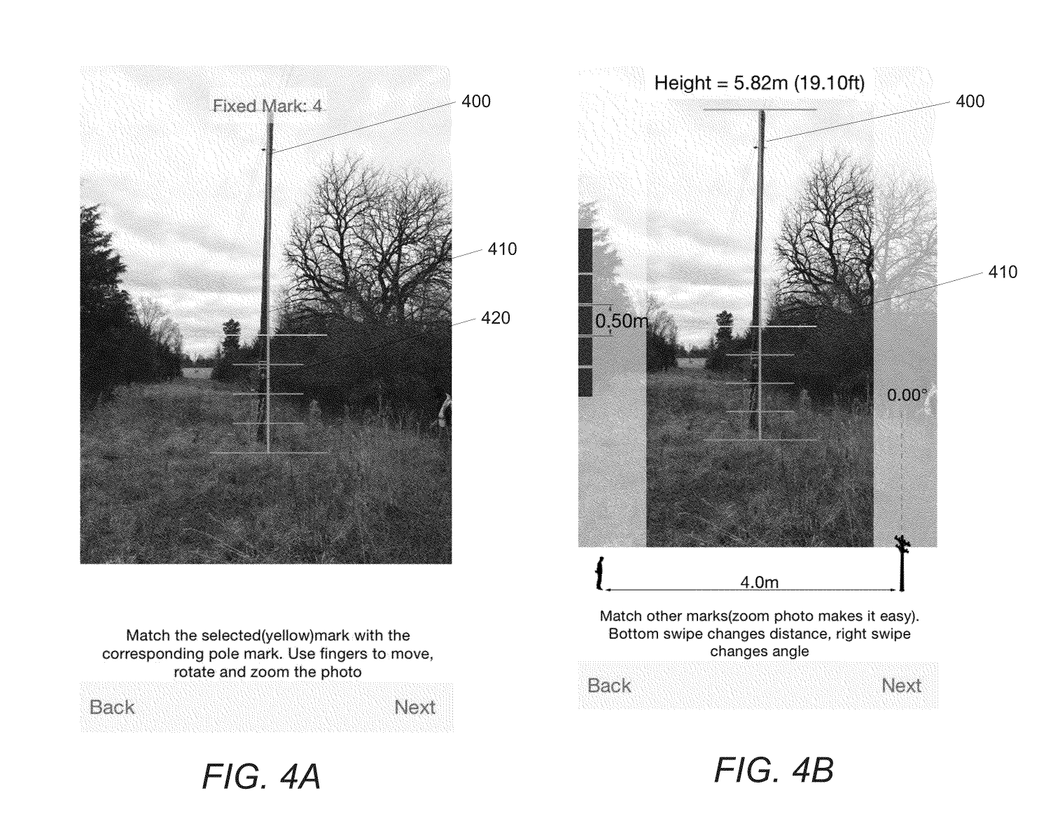

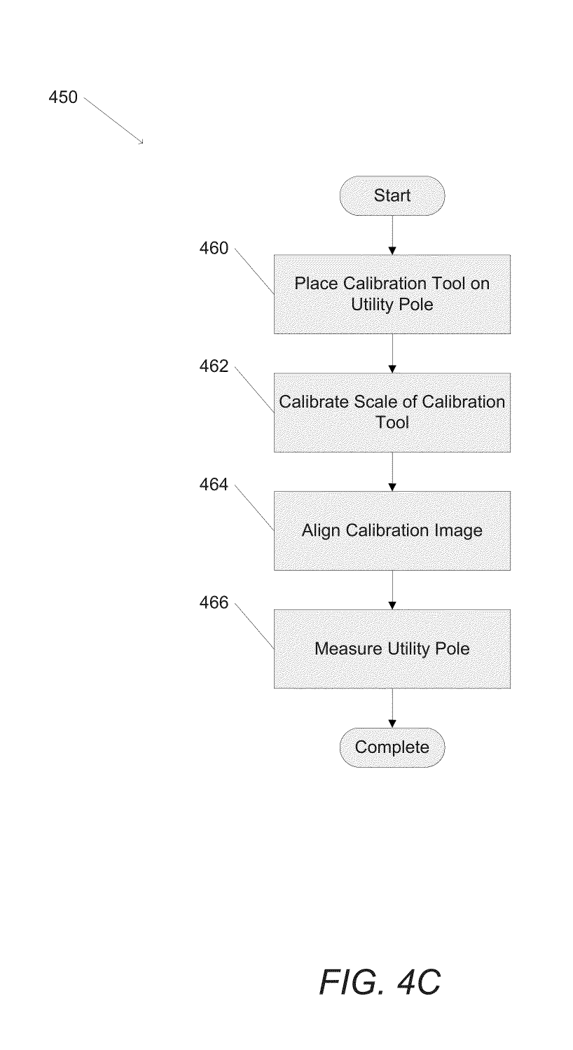

During the inspection of a utility pole, it is valuable to measure the orientation and height of the pole in addition to measuring the integrity of the pole. In this way, a complete determination of the condition of the pole can be determined. A user interface for measuring the height and angle of a utility pole in accordance with an embodiment of the invention is conceptually illustrated in FIGS. 4A and 4B. Turning now to FIG. 4A, a utility pole 400 has a calibration tool 420 attached to it. The calibration tool 420 has one or more calibration marks that are at pre-determined locations on the calibration tool 420. Additionally, in a variety of embodiments the calibration tool 420 is of a known size. The calibration tool 420 can be removably affixed to the utility pole 400 and/or be temporarily affixed to the utility pole 400. The measurement marker 410 is then aligned so that the marks in the measurement marker 410 align to the calibration marks on the calibration tool 420. The number of marks in the measurement marker 410 can be dynamically determined based on the particular details of the calibration tool being used. Turning now to FIG. 4B, the size and/or angle of the measurement marker 410 are modified to match the visual appearance of the utility pole 400. Based on the change in size and/or angle, the height of the measurement marker 410 can be calculated based on the size of the calibration tool 420. In a variety of embodiments, the calibration tool 420 is oriented perpendicular to the ground. In this way, the height of the utility pole along with the angle that the utility pole rests relative to the ground can be calculated.

Turning now to FIG. 4C, a flow diagram conceptually illustrating a process for measuring a utility pole in accordance with an embodiment of the invention is shown. The process 450 includes placing (460) a calibration tool on the utility pole. The scale of the calibration tool is calibrated (462) and the calibration image is aligned (464). The utility pole is measured (466). The utility pole can be measured (466) in real time using a camera included in a site inspection device and/or measured offline based on an image of the utility pole captured using the site inspection device.

A specific user interface along with a specific process for measuring utility poles is described above with respect to FIGS. 4A-4C; however, any of a variety of processes can be utilized to measure any object being monitored as appropriate to the requirements of a specific application in accordance with embodiments of the invention. Interfaces and methods for managing site inspection data and site inspection profile data in accordance with embodiments of the invention are described in more detail below.

### Monitoring Site Inspection Profile Data

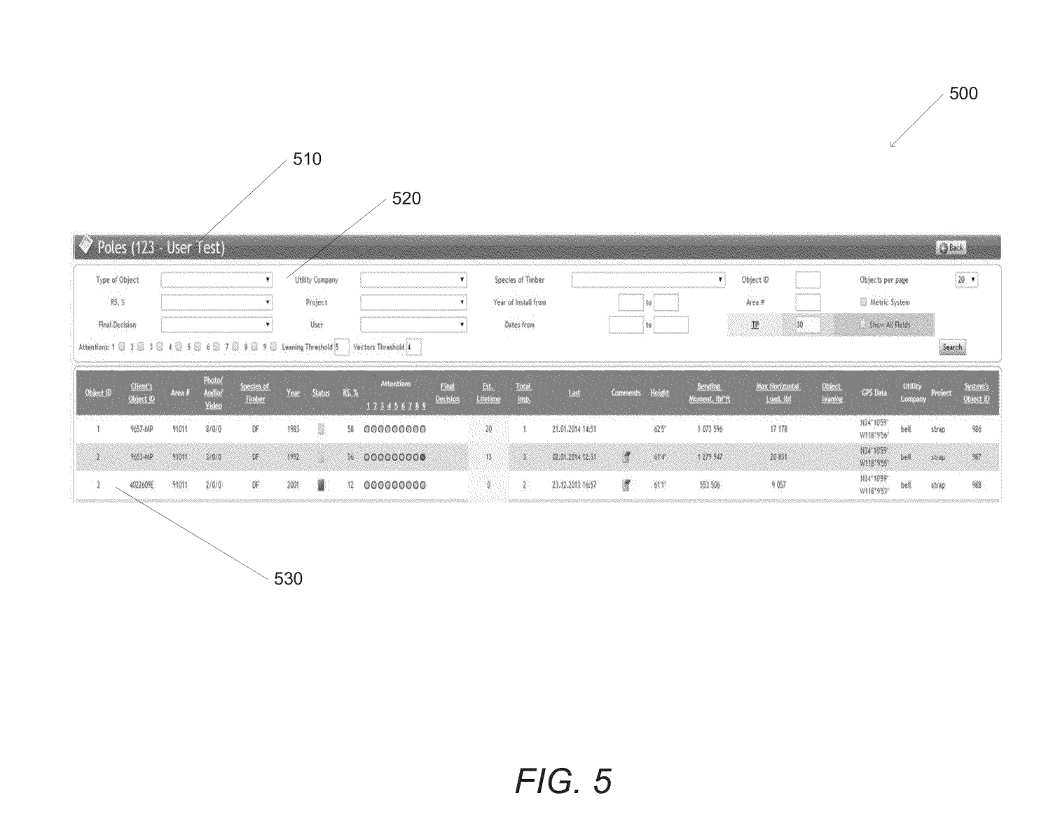

Once measured in the field and transmitted to a pole integrity monitoring server system, a variety of user interfaces can be employed to visualize and interact with the site inspection profile data. Once such interface in accordance with an embodiment of the invention is conceptually illustrated in FIG. 5. The user interface 500 includes an assigned engineer 510, a set of filters 520, and a listing of pieces of site inspection profile data for a variety of utility poles 530. The filters 520 can be utilized to identify one or more pieces of site inspection profile data according to one or more properties of the site inspection profile data described above. This listing 530 provides a quick overview of one or more pieces of site inspection profile data that can be selected for further analysis. In a variety of embodiments, the user interface 500 is displayed using a client device utilized by the assigned engineer 510. In many embodiments, the user interface 500 is displayed using a site inspection device. The site inspection device can utilize site inspection profile data obtained from a site inspection monitoring server system and/or stored locally on the site inspection device. The displayed pieces of site inspection profile data can include, but are not limited to, the most recent inspection for a utility pole, a predetermined inspection for the utility pole, an aggregate of one or more inspections of the utility pole, and/or any other summary of the inspection data as appropriate to the requirements of specific applications of the invention.

Although a specific user interface for displaying and interacting with site inspection profile data in accordance with an embodiment of the invention is conceptually illustrated in FIG. 5, any of a variety of interfaces can be employed as appropriate to the requirements of a specific application in accordance with embodiments of the invention. Techniques for generating site inspection profile data in accordance with embodiments of the invention are described in more detail below.

### Generating Site Inspection Profile Data

Many site inspections are for existing utility poles that may have had several inspections over an extended period. By tracking the site inspection profile data for a pole over time, the integrity of the pole along with any damage to the pole can be tracked and monitored. Additionally, the historical data along with the current data can be utilized to generate models describing the current integrity and condition of the utility pole. This tracking and modeling facilitates the recommendation to repair and/or replace the utility pole. Any portion of the site inspection profile data, including those described above, can be tracked and/or updated utilizing processes similar to those described above. However, it should be noted that any techniques for refining site inspection data and/or pole integrity data that can be incorporated into the historical site inspection profile data to continuously update the site inspection profile data can be utilized as appropriate to the requirements of specific embodiments of the invention. For example, the historical site inspection profile data can include those pieces of site inspection profile data occurring after a particular date. In several embodiments, new pieces of site inspection profile data can be appended to the historical site inspection profile data. In a variety of embodiments, the historical site inspection profile data is modified based on the new site inspection profile data. In many embodiments, the historical site inspection profile data is an aggregation of the pieces of site inspection profile data related to the particular utility pole.

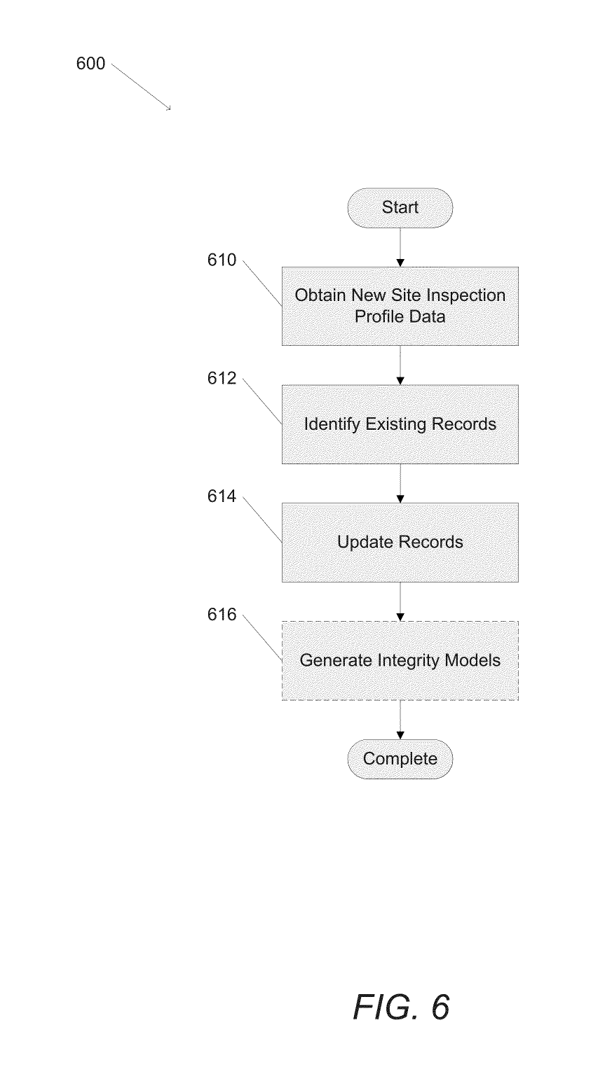

A flow diagram conceptually illustrating a process for generating site inspection profile data in accordance with an embodiment of the invention is shown in FIG. 6. The process 600 includes obtaining (610) new site inspection profile data. Existing records are identified (612) and updated (614). In several embodiments, integrity models are generated (616).

A specific process for generating and updating site inspection profile data in accordance with an embodiment of the invention is conceptually illustrated in FIG. 6, any of a variety of processes can be utilized as appropriate to the requirements of a specific application in accordance with embodiments of the invention. Processes for modeling site inspection profile data in accordance with embodiments of the invention are discussed further below.

### Generating and Viewing Pole Integrity Data

Once the strength of a utility pole is determined, the amount of load that the structure can bear is determined. According to the values determined, the user can then make a decision as to whether or not the utility pole needs immediate replacement, or provide an estimated time as to when such replacement may need to occur. Additionally, since the strength of the pole has been determined, the amount of load that can be placed onto the utility pole that does not result in the critical load value can be calculated. Should the value determined indicate that the utility pole cannot maintain the current load value, necessary next steps such as replacing the entire structure or, if possible, reducing the amount of load currently applied to the utility pole can be taken. The level of deterioration or decay of the utility pole identified during a site inspection can additionally affect the strength of the pole. Pole integrity models in accordance with embodiments of the invention can be utilized to visually represent the strength of the utility pole along with any points of interest (e.g. deterioration) noted with respect to the pole. Additionally, these points of interest can be associated with image data showing the deterioration or other points of interest. In this way, the status of a utility pole can be analyzed when not in the field and the condition of the utility pole can be tracked over time. In many embodiments, pole integrity model data is based on measured pole integrity data and/or pole structure data describing the physical characteristics of the measured utility pole. In this way, the pole integrity model data can be calculated based on the characteristics of the specific utility pole being measured, facilitating the accurate modeling of the strength of the utility pole based on the points of interest, the characteristics of the pole, and the measured pole integrity data.

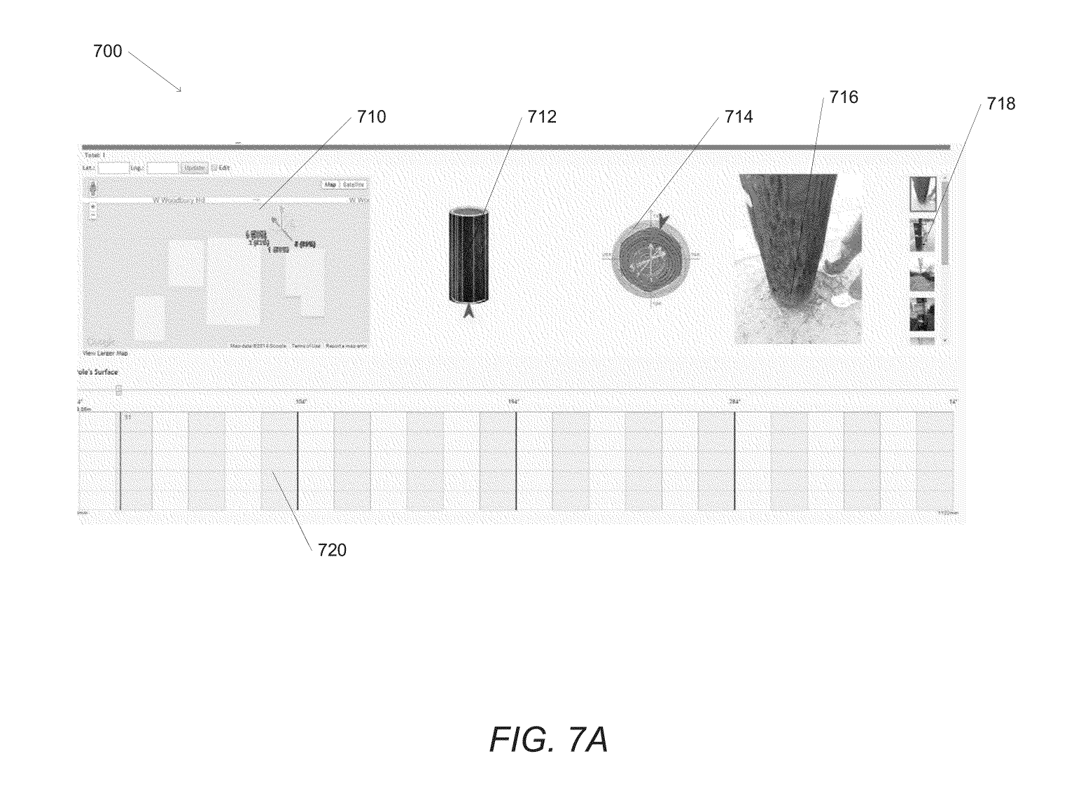

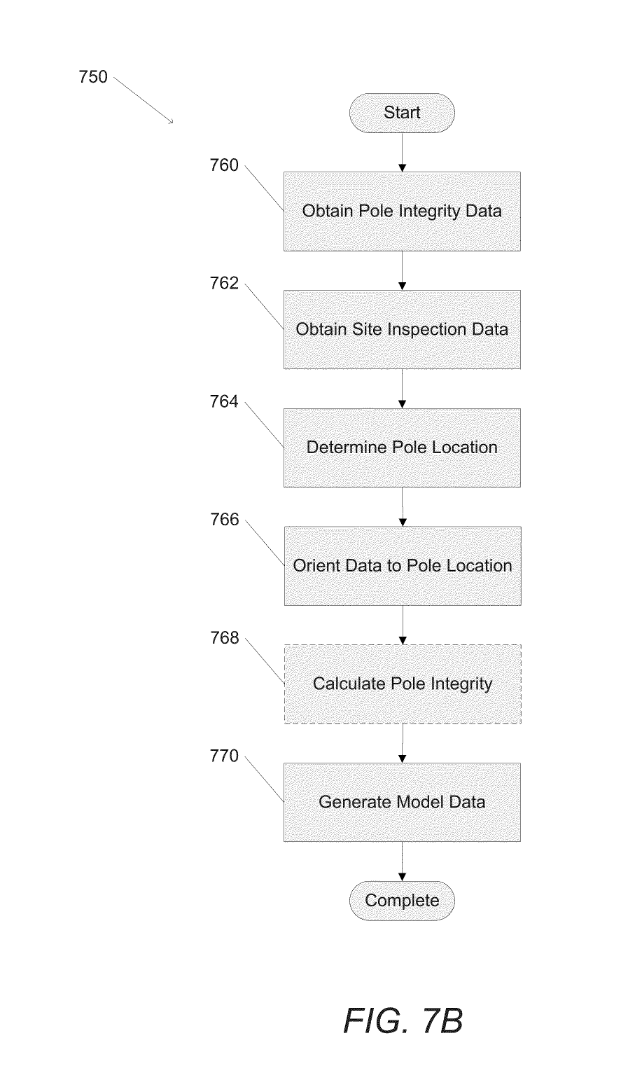

Turning now to FIG. 7A, a conceptual illustration of a user interface for viewing and interacting with utility pole model data in accordance with an embodiment of the invention is shown. The user interface 700 includes site location data 710 describing the location of the utility pole within the site. The user interface 712 also includes a visual rendering 712 of the utility pole, a cross section 714 of the utility pole, image data 716 of the utility pole, a listing 718 of all photos of the utility pole, and an unrolled view 720 of the utility pole. The visual rendering 712 of the utility pole provides a convenient interface for quickly identifying portions of the utility pole that have site inspection data associated with them. The cross section 714 provides a view of the different points of interest in the utility pole along with vector information describing the orientation of the points of interest within the utility pole. Image 716 provides an image captured during the inspection of the utility pole visually illustrating the point of interest, while the listing 718 of images provides a convenient interface for identifying those points of interest to be examined in more detail. The unrolled view 720 of the utility pole provides a broad overview of the utility pole based on the degree (i.e. the degrees from zero taking the utility pole as roughly a circle) of the location of the points of interest within the utility pole. Additionally, pole integrity data for different portions of the utility pole can be quickly visualized and identified using the unrolled view 720. In this way, the internal structure of the utility pole can be visualized based on the characteristics of the utility pole, the measured pole integrity data, and/or the identified points of interest.

A flow diagram conceptually illustrating a process for generating model data for a utility pole in accordance with an embodiment of the invention is shown in FIG. 7B. The process 750 includes obtaining (760) pole integrity data and obtaining (762) site inspection data. The pole location is determined (764) and the data is oriented (766) to the pole location. In many embodiments, the pole integrity is calculated (768). Model data describing the utility pole is generated (770). In a variety of embodiments, the model data describes external features of the utility pole. In several embodiments, the model data describes internal features of the utility pole computed using the pole integrity data and pole structure data based on the site inspection data.

Although a specific user interface along with a specific process for generating and manipulating model data for utility poles is described above with respect to FIGS. 7A and 7B, any of a variety of processes and interfaces can be utilized as appropriate to the requirements of a specific application in accordance with embodiments of the invention.

### Generating and Viewing Pole Integrity Data

In many embodiments, a variety of reports can be generated based on the inspection of a particular site. For example, if an inspection indicates that a pole needs maintenance, a variety of reports can be generated regarding the work to be done.

One type of report that can be generated is a financial report. Report data describing a financial report can include a set of work orders to be performed along with the associated cost for each work order. The report data can include settings for costs associated with all steps of work as parts, equipment, labor of various workers, etc. . . . The costs and steps can be pre-generated and/or generated based on the specific site inspection report data as appropriate to the requirements of specific applications of embodiments of the invention. The cost data can include costs related to the minimum cost, the maximum cost, the average cost for replacement and/or repair. The financial report data can be transmitted to a third-party server system, pole integrity monitoring server systems, and/or client devices. In many embodiments, the report data can include approval data indicating if some or all of the work is to be performed.

A second type of report is a work order report. In many embodiments, work order report data is generated once a financial report is approved, i.e. after approval data is obtained for a particular piece of financial report data. The work order report data can describe specific operations needed to be done for each particular site and/or project. In a number of embodiments, the work order report data includes digital documentation of data related to the site inspection data. This data can be filtered and/or secured based on the particular user who is viewing and/or assigned to the work order report data. That is, specific users can be described by metadata included in the work order report data, such as the engineers who are assigned to perform the work specified in the report. The work order report data can also include status data describing the current status of the work order, i.e. new, in progress, completed, etc. . . . . Additionally, notes and other data describing the work can also be included utilizing processes similar to those described above.

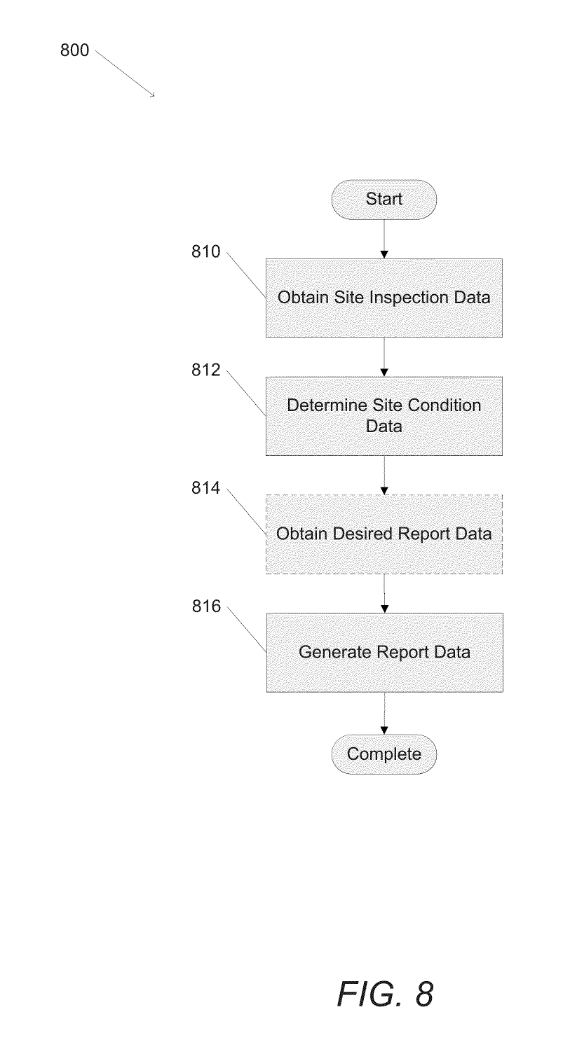

A flow chart conceptually illustrating a process for generating report data in accordance with an embodiment of the invention is shown in FIG. 8. The process 800 includes obtaining (810) site inspection data, determining (812) site condition data, and in a variety of embodiments obtaining (814) desired report data. Report data is generated (816).

Specific processes for generating report data are described above with respect to FIG. 8; however, any of a variety of processes and interfaces can be utilized as appropriate to the requirements of a specific application in accordance with embodiments of the invention.

Although the present invention has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A site inspection device, comprising:
a processor; and
a memory connected to the processor and storing a site inspection application;
wherein the site inspection application directs the processor to:
obtain site inspection data regarding a particular site having at least one structure;
generate pole integrity data based on the site inspection data, where the pole integrity data describes the integrity of the at least one structure;
generate site inspection profile data based on the site inspection data and the pole integrity data; and
provide the site inspection profile data.

2. The site inspection device of claim 1, wherein the site inspection data is obtained using a pole integrity meter.

3. The site inspection device of claim 2, wherein:
the pole integrity meter comprises a processor and a vibration sensor; and
the pole integrity meter measures the structural integrity of a structure in the at least one structure by:
inputting one or more strength determining characteristics of the structure into the pole integrity meter;
applying the vibration sensor to the structure;
creating a vibrational frequency signal within the structure;
measuring said frequency signal with the vibration sensor;
analyzing the measured frequency signal; and
providing data output of the analyzed frequency signal.

4. The site inspection device of claim 3, wherein site inspection application further directs the processor to:
generate pole integrity data based on the provided data output of the pole integrity meter; and
include the pole integrity data in the site inspection profile data.

5. The site inspection device of claim 2, wherein the site inspection device further comprises the pole integrity meter.

6. The site inspection device of claim 1, wherein the at least one structure comprises a utility pole.

7. The site inspection device of claim 1, wherein:
the utility pole is identified using a utility pole identifier; and
the site inspection application further directs the processor to:
obtain utility pole identifier data describing the utility pole; and
include the utility pole identifier data in the site inspection profile data.

8. The site inspection device of claim 1, wherein:
the site inspection device further comprises a global positioning system (GPS) receiver; and
the site inspection application further directs the processor to:
obtain location data using the GPS receiver; and
include the location data into the site inspection data.

9. The site inspection device of claim 1, wherein the site inspection profile data is provided to a pole integrity monitoring server system.

10. The site inspection device of claim 1, wherein the site inspection application further directs the processor to:
capture image data regarding the at least one structure;
identify calibration tool data within the image data, where the calibration tool data describes a calibration tool applied to the at least one structure;
measure the at least one structure based on the captured image data and the identified calibration tool to generate structure measurement data; and
include the structure measurement data in the site inspection profile data.

11. A method for performing a site inspection, comprising:
obtaining site inspection data regarding a particular site having at least one structure using a site inspection device, where the site inspection device comprises a processor and a memory;
generating pole integrity data based on the site inspection data using the site inspection device, where the pole integrity data describes the integrity of the at least one structure;
generating site inspection profile data based on the site inspection data and the pole integrity data using the site inspection device; and
providing the site inspection profile data using the site inspection device.

12. The method of claim 11, wherein the site inspection data is obtained using a pole integrity meter.

13. The method of claim 12, wherein:
the pole integrity meter comprises a processor and a vibration sensor; and
the pole integrity meter measures the structural integrity of a structure in the at least one structure by:
inputting one or more strength determining characteristics of the structure into the pole integrity meter;
applying the vibration sensor to the structure
creating a vibrational frequency signal within the structure;
measuring said frequency signal with the vibration sensor;
analyzing the measured frequency signal; and
providing data output of the analyzed frequency signal.

14. The method of claim 13, further comprising:
generating pole integrity data based on the provided data output of the pole integrity meter using the site inspection device; and
including the pole integrity data in the site inspection profile data using the site inspection device.

15. The method of claim 12, wherein the site inspection device further comprises the pole integrity meter.

16. The method of claim 11, wherein the at least one structure comprises a utility pole.

17. The method of claim 11, further comprising:
obtaining utility pole identifier data describing the utility pole using the site inspection device; and
including the utility pole identifier data in the site inspection profile data using the site inspection device.

18. The method of claim 11, further comprising:
obtaining location data using the site inspection device; and
including the location data into the site inspection data using the site inspection device.

19. The method of claim 11, wherein the site inspection profile data is provided to a pole integrity monitoring server system.

20. The method of claim 11, further comprising:
capturing image data regarding the at least one structure using the site inspection device;
identifying calibration tool data within the image data, where the calibration tool data describes a calibration tool applied to the at least one structure using the site inspection device;
measuring the at least one structure based on the captured image data and the identified calibration tool to generate structure measurement data using the site inspection device; and
including the structure measurement data in the site inspection profile data.
